(19) United States
(12) Patent Application Publication
(10) Pub. No.: US 2006/0001524 A1
(43) Pub. Date: Jan. 5, 2006

(54) System for automated verification of identification documents

(76) Inventor: Stuart Thorn, Boca Raton, FL (US)

Correspondence Address: National IP Rights Center, LLC;Suite 400, 550 Township Line Road, Blue Bell, PA, 19422, US

(21) Appl. No.: 10/885,288

(22) Filed: Jul. 2, 2004

(51) Int. Cl. H04Q 1/00; G05B 19/00

(52) U.S. Cl. 340/5.86; 340/5.32

(57) ABSTRACT

A system for checking the authenticity of a form of identification; a local reader for reading a form of authentication; a transmitter associated with the local reader for transmitting the information to a central location; a system at the central location for verifying the information with an authority which has issued the identification and for transmitting back to the local reader an indication that the form of identification is valid.

### FIELD OF THE INVENTION

The present invention is directed to the verification of information on a driver's license and similar documents such as those issued by governmental departments of motor vehicles and other authorities. In particular, the invention provides a method for organizations that require proof of identity to quickly authenticate verification of license or similar information with transmitting personal information.

### BACKGROUND OF THE INVENTION

Systems that enable the verification of licenses and vehicle registration information have been available for years. These systems have historically been available solely to law enforcement agencies and the like. There has arisen a greater need for these types of systems in the general marketplace, particularly for establishments that sell alcohol, banks and financial institutions, retail stores and the like which typically use driver's licenses as a form of identification. With the rise of identity theft, these organizations have a compelling need for up-to-date information by which to verify the bona fides of individuals seeking to transact business, in which a valid form of identification is required.

A number of patents have been issued directed to driver license authentication systems and the like, principally for use by law enforcement. U.S. Patent Publication No. 2003/0071730 discloses an information retrieval system for providing information concerning a driving and criminal record of a driver stopped for a traffic violation to a law enforcement officer. The system includes a card reading device for scanning data stored on a magnetic strip of a driver's license, a processor for analyzing the scanned data and a monitor for displaying the analyzed data. A transmitter wirelessly transmits the scanned data to a central station and a receiver receives an information signal from the central station concerning a person identified by the scanned driver's license. A printer is connected to the processor for printing a ticket concerning a violation committed. The received information signal is displayed on the monitor for viewing by the officer. The card reading device includes a first key for activating the transmitter to transmit the scanned data. The card reading device further comprises a transmit alert key for activating the transmitter to transmit the information signal to police vehicles within an area and an offense transmission key for transmitting a data signal indicative of a traffic offense committed, wherein the central station prints and mails a traffic ticket to the person identified in the driver's license.

Several patents have similarly been directed to the monitoring of license plates. U.S. Patent Application No. 6,269,372 to Wertheim, is a method for requesting a date with a driver of a vehicle spotted having a license plate number, via the license plate number of the vehicle. The method includes the steps of registering for a “PLATEDATE”.™. database, creating a profile on the “PLATEDATE”.™. database including license plate number, state vehicle is registered in, and E-mail address, spotting the vehicle whose driver you wish to date, accessing the “PLATEDATE”.™. database, inputting required information including the license plate number of the vehicle spotted, state the vehicle spotted is registered in, license plate number of vehicle of inquirer, and state of the vehicle of the inquirer is registered in, comparing the required information inputted to the “PLATEDATE”.™. database, sending the message to E-mail address of the driver of the vehicle spotted, if comparing step indicates a match, and creating an E-mail account, if comparing step indicates no match.

U.S. Pat. No. 6,641,038 discloses a smart vehicle registration plate for a vehicle have a computing unit configured to process vehicle related information, and a display, the display having one or more information display regions, for displaying the vehicle related information. The information display regions may be updateable by the computing unit as a function of changes to the vehicle related information.

While there have been a number of technologies directed to license authentication systems, none have been directed to an easy to utilize system which permits companies such as banks and other financial institutions, retail stores, taverns and food establishments to quickly and easily determine the validity of a driver's license used for identification. Such a system would be a great assistance in preventing identity theft and fraud.

It is therefore an object of the present invention to provide a system which provides the ability to rapidly obtain an indication of whether identification indicia are valid or invalid.

It is a further object of the present invention to provide a system whereby banks, financial institutions and the like can quickly confirm the validity and authenticity of identification.

It is still a further object of the present invention to provide a system wherein an identity of a person can be verified.

These and other objects of the present invention will become apparent from the detailed description which follows.

### SUMMARY OF THE INVENTION

The present invention is a system for checking the authenticity of a form of identification comprising a local client reader for reading information from a form of authentication presented by a customer; a transmission system associated with the local client reader for transmitting the information to a gateway system, the gateway system verifying the information with the authority that issued the identification and transmitting back to the local reader an indication that the form of identification is either valid or invalid based upon a comparison of the customer and issuing authority data.

In a further embodiment, the invention is a system for checking the authenticity of a form of identification comprising: a local reader associated with a client station for reading information from a form of governmental authentication presented by a customer; a transmitter associated with the local client data reader for transmitting the information to a gateway system; the gateway system having means for contacting a government entity, and obtaining a corresponding record from the government entity related to the form of identification presented by the customer and for transmitting back to the local reader an indication of whether the form of identification presented by the customer is valid or invalid.

In still a further embodiment, the invention is system for checking the authenticity of a form of governmental identification comprising: a local reader associated with a client station for reading information from a form of governmental authentication from a customer; a transmitting system associated with the local client data reader for transmitting the information to a gateway system; the gateway system having means for contacting a government entity and obtaining a corresponding record associated with the information from the government entity, for comparing the same and for transmitting back to the local reader an indication of whether the form of identification is valid or invalid.

In yet a further embodiment, the invention is a system for checking the authenticity of a form of governmental identification comprising: a local reader associated with a client station for reading information from a form of governmental authentication presented by a customer; a transmitting system associated with the local client data reader for transmitting the information to a gateway system; the gateway system having means for contacting a government entity and obtaining a corresponding record associated with the information from the government entity, and for comparing the same based upon a level of accuracy requested by the client and for transmitting back to the local reader an indication of whether the form of identification is valid or invalid at the requested level of accuracy.

### BRIEF DESCRIPTION OF THE FIGURES

FIGS. 1A and 1B are flow diagrams of the present invention FIG. 2 is a block diagram of the gateway bureau.

FIG. 3 is a block diagram of the local agent system of the present invention.

FIG. 4 is an algorithmic flow diagram of the operation of the present invention.

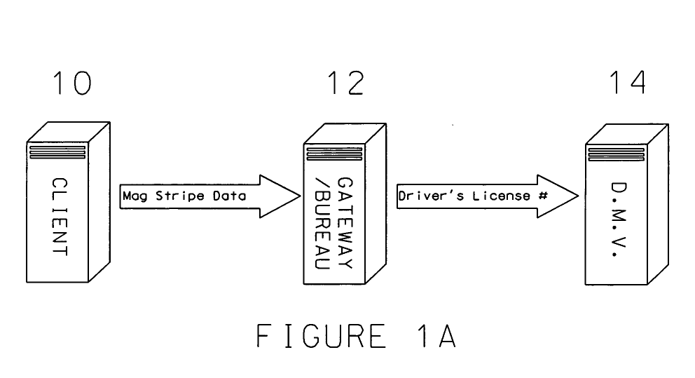

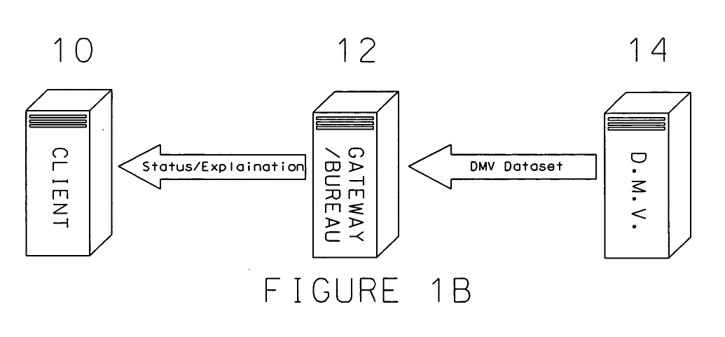

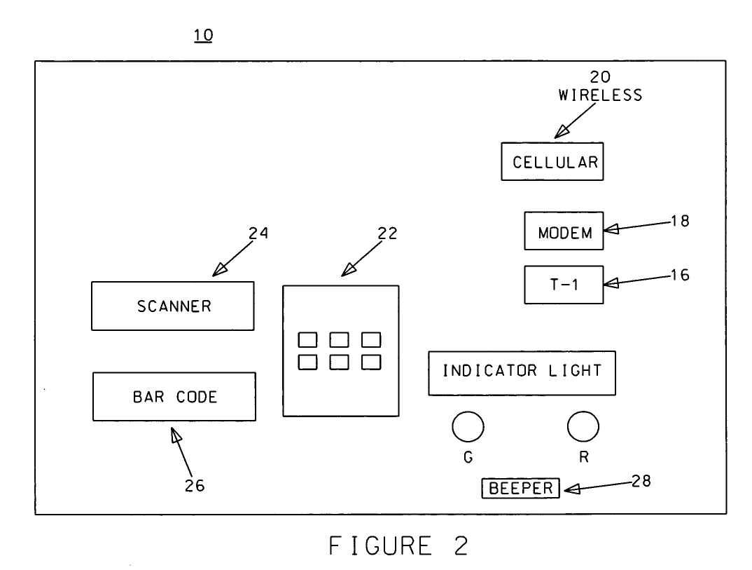

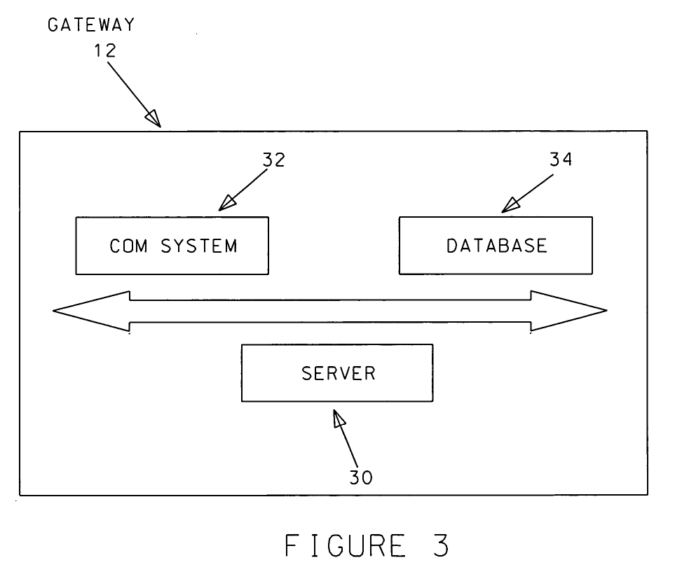

### DESCRIPTION OF THE PREFERRED EMBODIMENT

Referring to the Figures, the present invention is now described in detail. The present invention is broadly directed to a system for the verification of a form of identification such as a driver's license. In particular, the present invention is directed to a system and method for organizations and entities that require an official identification such as a diver's license as proof of identity, to automatically verify the authenticity of the license presented.

The identity document, referred to herein as a “driver's license,” could be any centrally-recorded document from which information can be read automatically, (i.e., via magnetic stripe, one-or-two-dimensional barcode, smart or chip card, characters or fingerprint). The driver's license or identification may also have a picture. While the present invention is being described in the context of a driver's license, the teachings of the invention are equally applicable to a wide array of forms of identification including military identification badges, passports, and even commercial and student identification badges.

In particular, the present invention comprises three basic elements. The system broadly comprises a client system 10, gateway/electronic bureau 12 and a record keeping authority 14 such as a state DMV. The client system 10 is retained at the location of a member user (hereinafter client) such as a bank, tavern or retail establishment where a form of identification is required from customers. The client system 10 may be connected to a phone line, T-I line 16, cellular transponder or wireless communication system 20. The system at the client's location will further include a bar code 26 reader, scanner 24 or manual data input means such as a keypad 22. The client system will further have a means to indicated whether a form of identification is valid, such as a light or beeper 28. For example, if an identification is valid, a green light may be activated. A red light may activate if the identification is invalid.

Depending upon the nature of the client (e.g. whether it is a bank or tavern), the client system can further be configured to require only partial verification. For example, a client such as a tavern may require only verification of name, age and physical characteristics, whereas a bank or financial institution may require a verification of all information on the license, including such data as whether the customer requires glasses while driving and chose to be an organ donor. The data will be encrypted by the client system for transmission to the gateway electronic bureau 12. This ensures privacy and restricts use solely to authorized agents or those with a reporting mechanism for capturing unauthorized attempts for access.

The gateway electronic bureau 12 will typically have a central server 30, database 34 and communication system 32. The gateway bureau 12 will in turn transmit only the License ID number to the State (US or Foreign government) authority to obtain the information that will be compared with the information on the license presented at the client.

The record-keeping authority 14 (exemplified as a DMV) will transmit the information that should be on the license document presented. Upon receipt of the data from the record-keeping authority (DMV) 14, the gateway electronic bureau 12 compares the DMV data to the information obtained from the presented license using a simple match algorithm. The level of precision or accuracy will depend on the amount of data to be compared (i.e. if only some or all of the data is to be compared, as noted above).

The result of this comparison is then transmitted back to the client terminal. The requesting client 10 is provided with only the results of the comparison. The client is only informed whether the required level information matched or didn't match. No access is provided to the official records, the government entity is not given information about the request.

The gateway electronic bureau 12 records the event date, the document number, the originating terminal identity and the result of the comparison. No record of the information that was compared is retained after the result of the comparison is transmitted to the requesting client terminal.

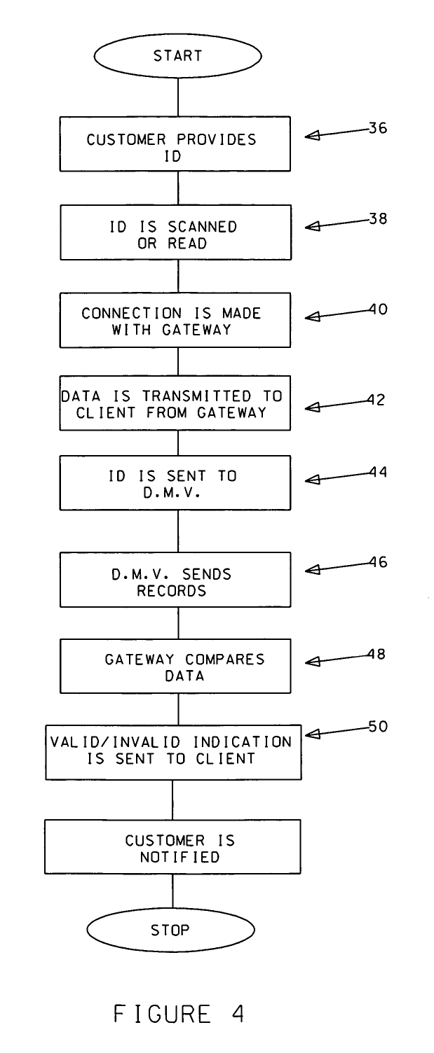

The over all operation is now described with reference to FIG. 4. It is important to note that the process described herein may be altered. Initially, a customer at a tavern or bank responds to a request for proof of identity by a client 10 by providing a Driver's License 36. The client using the client terminal swipes (or otherwise reads) the information on the Driver's License by means of a magnetic card reader, smart card reader, keypad or other media 38. If a permanent connection between the client 10 entity and gateway electronic bureau 12 does not exist, one is created, established and authenticated by a modem 40.

The entire contents resulting from the “read” at the client 10 (the “Dataset”) are transmitted to the gateway electronic bureau 42. If a permanent connection between the gateway for example and DMV is not present, one is opened, established and authenticated.

The gateway electronic bureau 12 forwards only the Driver's License ID Number 44 to the governmental host such as a state DMV 44. The DMV Host uses the ID number to retrieve the relevant record from the database and returns only the elements of information contained in the Driver's License Dataset to the bureau, as well as the status of the License 46. The gateway bureau 12 compares the returned data according to the established criteria using a match algorithm 48. The gateway bureau then forwards the results of this comparison to the client as a binary match or non-match 50.

The gateway bureau 12 retains only a data log as to the time, date, client name and customer license number No other information is saved or forwarded to the client. All non-permanent connections are then closed. In short, the client merchant, bank or tavern receives only a positive or negative (Yes/No) indication of the identification medium. The present invention thus provides a methodology for facilitating identification with the maximum level of privacy and security.

The present invention has been described with reference to the preferred embodiment. It is to be appreciated that other embodiments fulfill the spirit and scope of the present invention and that the true nature and scope of the invention is to be determined with reference to the claims appended hereto

1. A system for checking the authenticity of a form of identification comprising:
a local client reader for reading information from a form of authentication presented by a customer;
a transmission system associated with the local client reader for transmitting the information to a gateway system, the gateway system verifying the information with an authority that issued the identification and transmitting back to the local reader an indication that the form of identification is either valid or invalid based upon a comparison of the customer and issuing authority data.

2. The system for checking the authenticity of a form of identification of claim 1 wherein the local system activates a signal indicating whether the client information is verified or not verified.

3. A system for checking the authenticity of a form of identification comprising:
a local reader associated with a client station for reading information from a form of governmental authentication presented by a customer;
a transmitter associated with the local client data reader for transmitting the information to a gateway system;
the gateway system having means for contacting a government entity, and obtaining a corresponding record from the government entity related to the form of identification presented by the customer and for transmitting back to the local reader an indication of whether the form of identification presented by the customer is valid or invalid.

4. A system for checking the authenticity of a form of governmental identification comprising:
a local reader associated with a client station for reading information from a form of governmental authentication from a customer;
a transmitting system associated with the local client data reader for transmitting the information to a gateway system;
the gateway system having means for contacting a government entity and obtaining a corresponding record associated with the information from the government entity, for comparing the same and for transmitting back to the local reader an indication of whether the form of identification is valid or invalid.

5. The system of claim 4 wherein the transmitting system is a modem.

6. A system for checking the authenticity of a form of governmental identification comprising:
a local reader associated with a client station for reading information from a form of governmental authentication presented by a customer;
a transmitting system associated with the local client data reader for transmitting the information to a gateway system;
the gateway system having means for contacting a government entity and obtaining a corresponding record associated with the information from the government entity, and for comparing the same based upon a level of accuracy requested by the client and for transmitting back to the local reader an indication of whether the form of identification is valid or invalid at the requested level of accuracy.
